(19) United States
(12) Patent Application Publication
(10) Pub. No.: US 2004/0250137 A1
(43) Pub. Date: Dec. 9, 2004

(54) Host management apparatus, host management method, and host management program

(75) Inventor: Shinji Takahashi, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 10/827,250

(22) Filed: Apr. 20, 2004

(30) Foreign Application Priority Data
Apr. 21, 2003 (JP) P.2003-116190

(51) Int. Cl. H04L 9/00

(52) U.S. Cl. 713/201

(57) ABSTRACT

A host management apparatus (HMS) placed on a network to which the hosts of an electronic conference system are connected. The host information containing the IP address information on a site authenticated by a host authentication section for authenticating a selected host is acquired through a communication control section and is stored in a storage section by a host information management section, whereby the host information is registered in the host management apparatus. Therefore, problems of a complicated procedure, the incapability of flexibly increasing or decreasing the number of conference sites (hosts), apprehension that security cannot be ensured, etc., in an electronic conference system are solved.

### BACKGROUND OF THE INVENTION

1. Field of the Invention

The invention relates to a host management apparatus, a host management method, and a host management program, which is placed on a network to which hosts of an electronic conference system are connected.

2. Description of the Related Art

An electronic conference system in which a plurality of remote conference sites are connected through a network for transferring image, voice, sound, text, application data, and the like is widely available. For example, JP-A-2002-109444 discloses an electronic conference server system having a shared database for storing electronic files, etc., used in a conference. Client computers such as personal computers (PCs) of a conference organizer and conference participants are connected through a network such as a closed LAN or the Internet.

In such an electronic conference system in the related art, to call a conference site on the network, for example, using DNS (Domain Name System) of a system for establishing correspondences between the host names on the Internet and the IP addresses, the associated site may be determined by service of a DNS server.

FIG. 1 is a drawing to illustrate conference sites in the electronic conference system in the related art using the DNS. In the case that site A calls site B shown in FIG. 1, inquiry about the IP address of the site (in this case, site B) is sent from site A to a higher-rank name server for conducting name resolution.

JP-A-2002-10944 (especially, FIG. 1) is referred as a related art.

To use the DNS for the electronic conference system as described above, only the conference sites acquiring the global IP addresses or the domain names corresponding thereto can take part in a conference and therefore there is a problem of a complicated procedure in acquiring the domain names, etc., to construct conference sites.

In the electronic conference system in the related art, connection destinations as conference sites are managed for each site (host). This means that all hosts taking part in a conference requires previous registration of the addresses of all associated hosts. Thus, to change the conference sites taking part in a conference, registration of the addresses needs to be updated in all hosts and the number of conference sites cannot flexibly be increased or decreased; this is also a problem.

On the other hand, in a network conference system such as NetMeeting (registered trademark) provided by Microsoft (registered trademark), even a host having an unfixed IP address can become a conference site by registering a nickname, the electronic mail address, etc., for identifying the host in an ILS (Internet Locater Service) server.

This means that conference sites can be easily constructed even with dialup connection, etc., for dynamically assigning IP addresses from a DHCP (Dynamic Host Configuration Protocol) server.

However, any number of unspecific sites can be registered in the ILS server and therefore there is apprehension that security in the conference cannot be ensured; this is a problem.

### SUMMARY OF THE INVENTION

An object of the invention is to solve the problem of a complicated procedure and the problem of the incapability of flexibly increasing or decreasing the number of conference sites. Another object of the invention is to solve the problem of apprehension that security cannot be ensured in registering as a host in an electronic conference system or acquiring host information in the environment in which the IP addresses are not fixed.

The invention provides a host management apparatus being placed on a network to which hosts of an electronic conference system are connected, having a host authentication section for authenticating a selected host; and a host information registration section for registering host information including IP address information of a host authenticated by the host authentication section.

The invention also provides a host management method of managing host of an electronic conference system on a network, having the steps of authenticating a selected host; and registering host information including IP address information of a host authenticated in the step of authenticating the selected host.

The invention also provides a host management program of a host management apparatus being placed on a network to which hosts of an electronic conference system are connected, causing a computer to perform a host authentication function of authenticating a selected host, and a host information registration function of registering host information including IP address information of a host authenticated by the host authentication function.

### BRIEF DESCRIPTION OF THE DRAWINGS

FIG. 1 is a drawing to illustrate hosts (sites) in an electronic conference system in a related art using DNS;

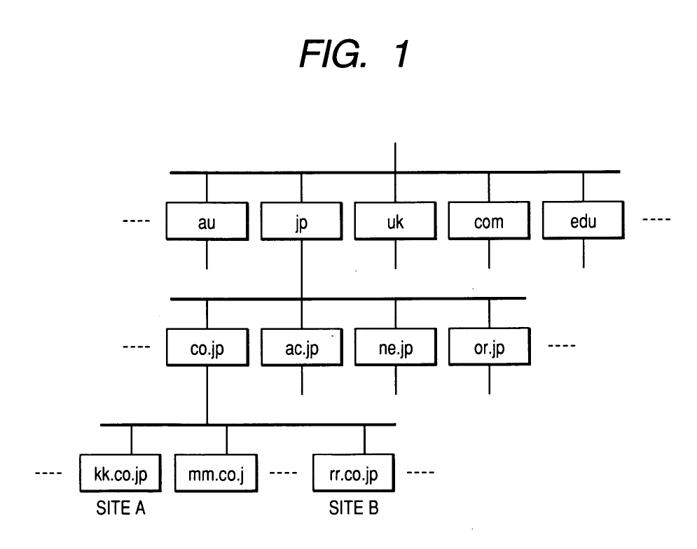

FIG. 2 is a block diagram to show the configuration of an electronic conference system in an embodiment of the invention;

FIG. 3 is a flowchart to show detailed steps of start processing of the host management apparatuses;

FIG. 4 is a flowchart to show detailed steps of host registration processing of the host management apparatuses;

FIG. 5 is a schematic drawing to show the case where a conference can be held only between hosts of the same company in host management apparatuses connected to a network such as the Internet;

FIG. 6 is a flowchart to show detailed steps of host information management processing of the host management apparatus;

FIG. 7 is a flowchart to show detailed steps of host information deletion processing of the host management apparatus;

FIG. 8 is a schematic diagram to show the relationship between the two host management apparatuses placed in remote locations and hosts;

FIG. 9 is a flowchart to show detailed steps of HMS-to-HMS information exchange processing of the host management apparatuses; and

FIG. 10 is a flowchart to show detailed steps of termination processing of the host management apparatuses.

### DETAILED DESCRIPTION OF THE PREFERRED EMBODIMENTS

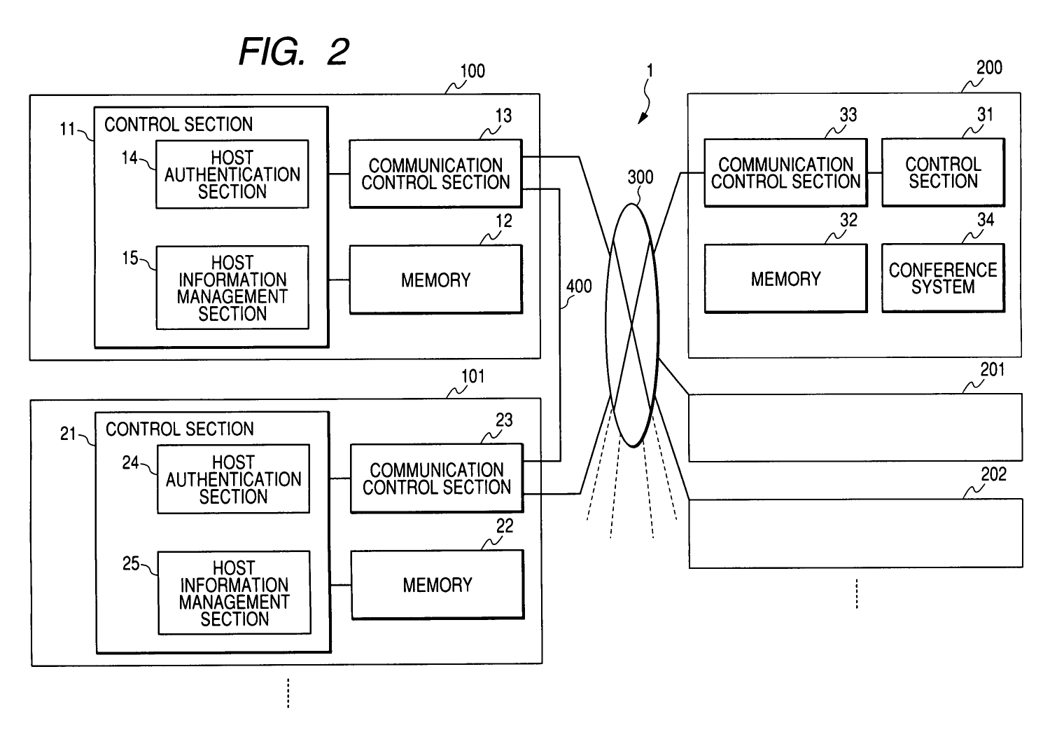

An embodiment of a host management apparatus, a host management method, and a host management program according to the invention will be explained in detail with reference to FIGS. 2 to 10.

An embodiment of the invention will be explained with reference to FIG. 2 showing the configuration of an electronic conference system.

As shown in FIG. 2, an electronic conference system 1 is configured from a plurality of hosts 200, 201, 202 and a plurality of host management apparatuses (HMS) 100, 101 connected to the network where the hosts exist.

Each of the host management apparatuses 100, 101 includes a control section 11, a storage section 12, and a communication control section 13 as main components. The control section 11 includes a host authentication section 14 and a host information management section 15.

The control section 11 controls the operation of the HMS 100 (HMS 101) by executing a control program. The host authentication section 14 in the control section 11 checks whether or not access from the host 200 (host 201, host 202) in the electronic conference system 1 is an access from the valid host.

The host information management section 15 stores the registrations of host information of the host name, the IP address, etc., of the host determined valid in the storage section 12 as a information storage section.

Further, the host information management section 15 updates the registrations of the host information stored in the storage section 12 in a predetermined cycle.

The storage section 12 stores the control program and application for the control section 11 to perform control, setup information of the HMS 100 (HMS 101), the host information registered from each host, and the like. The communication control section 13 communicates with the host 200 (host 201, host 202) through the network.

The host 200 includes a control section 31, a storage section 32, a communication control section 33, and an electronic conference system application 34.

The control section 31 controls the operation on the host 200 by executing a control program.

Preferably, the control program is supplied from the HMS 100 as an application for the host management apparatuses.

The storage section 32 stores the control program and application for electronic conference system for the control section 11 to perform control, various pieces of setup information, the host information acquired from each host, and the like. The communication control section 33 conducts communications with the HMSs 100, 101 through the network.

The electronic conference system 1 is thus configured, so that only the host information of the hosts in the conference system authenticated by the host authentication section is selectively registered in the host management apparatus HMS 100 (HMS 101).

Therefore, the host 200 (host 201, host 202) of the host of the electronic conference system 1 can find the hosts that can be connected for conference from among the hosts authenticated by the host authentication section by referencing the IP addresses of the registered host information.

As the data exchange operation between the HMSs described later is executed according to the configuration, even if one host management apparatus stops, if another host management apparatus is operating, the host management function can be maintained. The host management apparatuses may be connected using a network 300 (for example, the Internet, etc.,) to which the hosts are connected; they may be connected directly by a leased line 400.

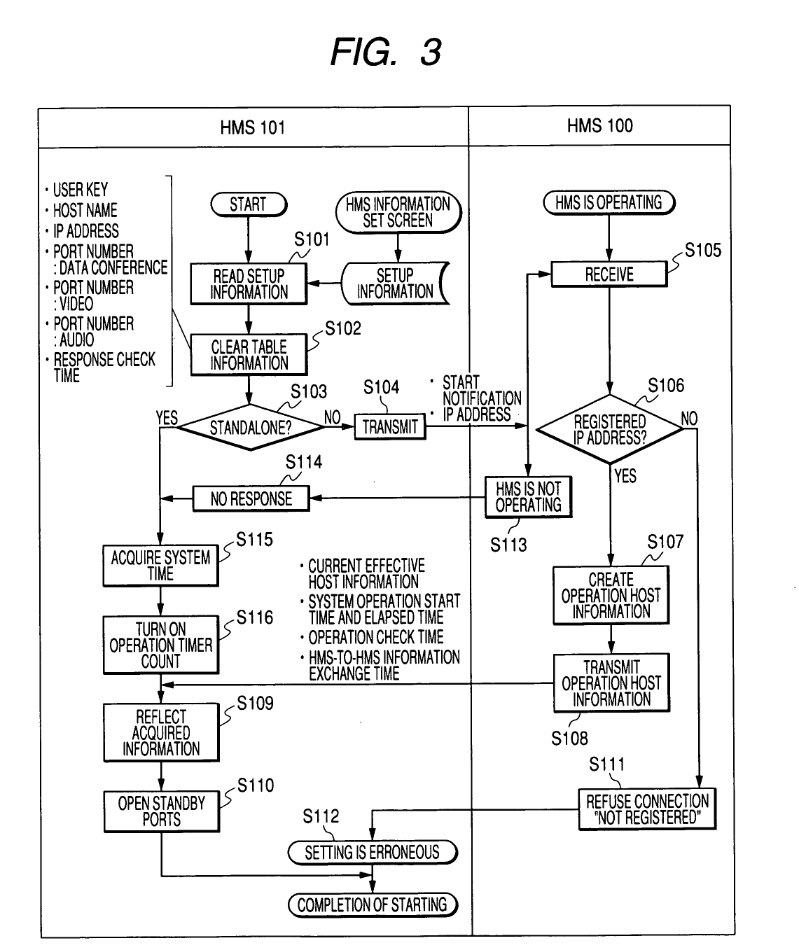

Next, an example of the operation of the host management apparatus in the embodiment will be explained with reference to FIGS. 3 to 8.

In the example, the HMS 100 and the HMH 101 exist in the electronic conference system 1, and the relationship between the HMSs 100, 101 and the host 200 of the electronic conference system 1 is shown.

The start operation of the HMS 100 and the HMS 101 will be explained with reference to FIG. 3. FIG. 3 is a flowchart to show detailed steps of start processing of the host management apparatuses. It shows processing steps where the HMS 100 is already operating.

When the HMS 101 is started, a control section 21 reads the setup information stored in a storage section 22 (step S101). The setup information is information of the IP address of the HMS 100, the retention file name of the setup information, the host operation check time, the HMS-to-HMS information exchange time, etc., and can be set on a set screen of a display section (not shown) of the HMS 101. The setup items are described later in detail.

Next, the control section 21 clears the information of a table saved in the storage section 22 (step S102). The table is used to register host information and contains the items of user key, host name, IP address, data conference, video, and audio port numbers, response check time, etc.

After clearing the table, the control section 21 determines whether or not the HMS 101 is set to a standalone mode (step S103). If more than one HMS is installed, it is possible that the HMS is set so that it operates on a standalone basis for some reason and therefore the determination is made at step S103.

If the HMS 101 is not set to the standalone mode, the control section 21 transmits a start notification and the IP address through a communication control section 23 to the other host management apparatus HMS 100 which is operating (step S104).

The control section 11 of the HMS 100 receives the notification from the HMS 101 through the communication control section 13 (step S105) and determines whether or not the IP address of the HMS 101 is the IP address previously registered (step S106).

If the received IP address of the HMS 101 is registered in the HMS 100, the control section 11 permits the HMS 101 to connect to the HMS 100 and creates operating host information (step S107).

The operating host information contains the host names of the registered hosts, the current effective host information, the start time and the elapsed operation time of the HMS 100, the host operation check time, the HMS-to-HMS information exchange time, etc. The control section 11 transmits the created operating host information to the HMS 101 through the communication control section 13 (step S108).

The control section 21 of the HMS 101 reflects the received information in the setting of the HMS 101 (step S109) and opens various processing standby ports (step

Specifically, as step S109 is executed, the operation time and the elapsed time of the HMS 101 are set to those of the HMS 100 and it is assumed that the HMS 101 also operates starting at the start time of the HMS 100. The registered host information is also set to the same host information as the HMS 100.

In the example in FIG. 3, the HMS 100 is first started and thus the control section 21 of the HMS 101 recognizes the HMS 100 as primary and the HMS 101 as secondary.

After this, the host information is exchanged between the HMS 100 and the HMS 101 in a predetermined cycle, whereby both the HMS 100 and the HMS 101 share the same host information. Whether the HMS is primary or secondary is determined depending on the start time of the HMS.

On the other hand, if it is determined at step S106 that the IP address received by the HMS 100 is not registered, the control section 11 of the HMS 100 determines that the HMS 101 is not authorized HMS, and refuses connection (step S111). A message to the effect that the setting is erroneous is displayed on the display section (not shown) of the HMS 101 (step S112).

Even if it is determined at step S103 that the HMS 101 is not set to a standalone mode and a start notification is transmitted to the HMS 100 at step S104, if the HMS 100 stops, no response is made (step S113).

If a predetermined time has elapsed or if no response is made although notification operation is repeated a predetermined number of times, the control section 11 of the HMS 100 determines that no response is made (step S114).

The control section 21 recognizes the HMS 101 as primary HMS and stores the start time of the HMS 101 in the storage section 22 (step S115) and starts timer count of the operation elapsed time (step S116). After this, the process goes to step S109 described above. Therefore, if the HMS 100 is later started, the HMS 100 becomes secondary HMS and executes similar start operation to that described above.

The HMS start operation is then completed. When a plurality of (two) HMSs thus operate, the host information of the primary HMS is supplied to the secondary HMS and the operating host information is shared therebetween. The host information update operation is described later.

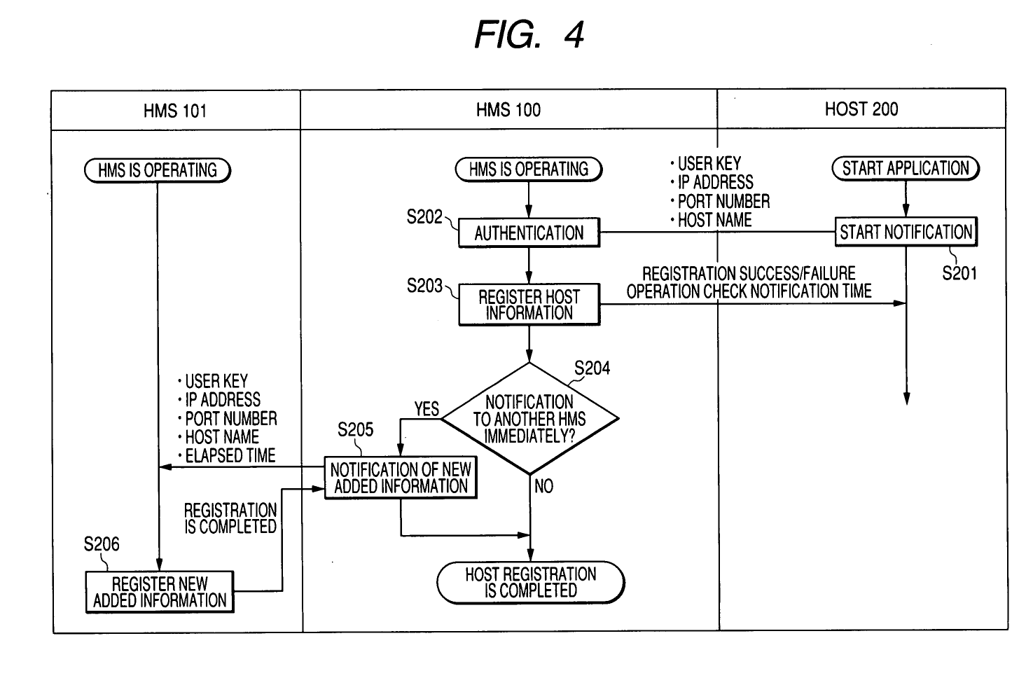

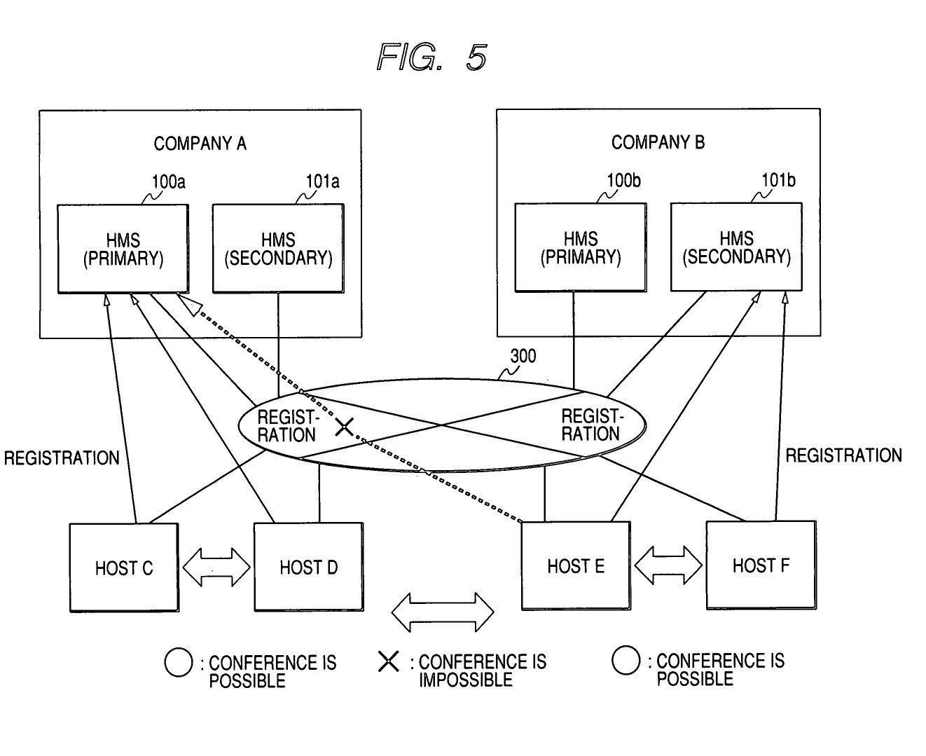

Next, the host registration operation of the host management apparatuses will be explained with reference to FIGS. 4 and 5. FIG. 4 is a flowchart to show detailed steps of the host registration processing of the host management apparatuses.

When the host management apparatus application at the host 200 is started, the control section 31 at the host 200 transmits a start notification to the primary HMS 100 (step S201). The start notification contains the host information of the host name, the IP address, the port number, the user key, etc.

The user key is the key unique to the user that can be known by only the user of the host management apparatus and therefore the host authentication section 14 of the HMS 100 authenticates the host based on the received user key (step S202).

As the authentication method, a known technique may be used. Only the host information of the host determined valid is stored in the storage section 12 by the host information management section 15 (step S203) and information as to whether or not host information registration resulted in success, the host operation check time, etc., is returned to the host 200.

If the HMS 100 cannot be accessed because the HMS 100 stops or for any other reason, the secondary HMS 101 is accessed for receiving similar authentication.

When the host information is registered, the control section 11 determines whether or not the registrations are to be immediately sent to the secondary HMS 101 (step S204).

This is predetermined as setup information of the HMS 100. To immediately send the registrations, the control section 11 sends the registrations to the HMS 101 as new added information (step S205).

The control section 21 of the HMS 101 receives the new added information and a host information management section 25 stores the registrations in the storage section 22 (step S206). A registration completion notification is returned to the HMS 100.

If it is not determined at step S204 that the registrations are to be immediately sent to the secondary HMS 101, the HMS 101 is updated with the registrations in the information exchange operation between the HMS described later.

The host registration operation of the HMSs is then completed.

The host information of only the host determined valid in authentication can be registered, so that the HMS can selectively register the authorized hosts even on the Internet through which a plurality of HMSs not related to each other are connected. Moreover, it is not necessary to previously register the host in the HMS.

FIG. 5 shows the case where a conference can be held only in the same company, for example, n the relationship between hosts and host management apparatuses connected to a network such as the Internet.

To enable a conference to be held only in the same company, for example, as shown in FIG. 5, an HMS 100a of a company A permits registration of the host information of only authorized conference sites (host C and host D of the company A) that can know the IP address of the HMS 100a and the user key to take part in the conference, and refuses unauthorized conference sites (host E and host F of company B) in authentication and the host information cannot be registered. Therefore, the host E of the company B cannot connect to the host C or D, the conference site of the company A registered in the HMS 100a for the electronic conference.

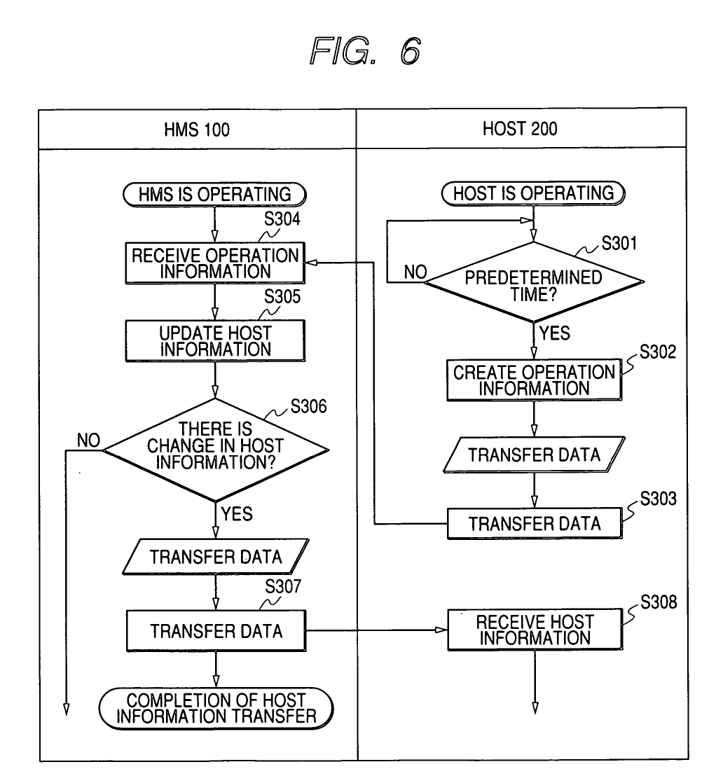

Next, the host information update operation of the host management apparatus will be explained with reference to FIG. 6. FIG. 6 is a flowchart to show detailed steps of the host information management processing of the host management apparatus.

Since different user groups may hold different conferences at the sites connected to the HMS, if a conference terminates or a new conference is held, the user name, the host name, the IP address, and the like are changed and thus the host information needs to be updated accordingly. Thus, to check the operation state of each host in a predetermined cycle, each host needs to transmit the operation information of the host (information indicating whether or not the host is connected to the electronic conference system and operates) to the HMS.

As shown at step S203 in the flowchart of FIG. 4, when the host information is registered in the HMS 100, a notification of registration completion and the host operation check time is sent to the host 200.

This host operation check time refers to the time interval for checking the operation state of each host in a predetermined cycle. For example, if the host operation check time is set to 600 seconds, the operation state on the host 200 is checked and is transmitted to the HMS 100 every 10 minutes.

As shown in FIG. 6, the host at the host 200 is operating and the control section 31 determines whether or not the host operation check time has elapsed based on the host operation check time sent from the HMS 100 (step S301). If a predetermined time has elapsed, the control section 31 creates operation information on the host 200 (step S302).

The control section 31 transmits the created operation information on the host 200 to the HMS 100 through the communication control section 33 (step S303). The HMS 100 receives the operation information on the host 200 through the communication control section 13 (step S304).

The host information management section 15 adds the received host operation information to the storage section 12 to update the host information (step S305).

The host information management section 15 (control section 11) determines whether or not there is change in the updated host information (step S306) and if there is change in the host information, transmits the updated host information to the host 200 (step S307).

In the host information update processing, for example, if the host information containing the same user name, host name, IP address is added as the host operation information, a situation in which one conference is terminated and a new conference is held in a different host or the same user takes part in conference with dialup connection (unfixed IP address) is assumed and therefore the host information containing the old user name and IP address is replaced with the most recent host information. Host information deletion processing is described later.

Upon reception of the updated host information, the control section 31 at the host 200 stores the received host information in the storage section 32 (step S308). The received host information contains the user name, the host name, the IP address, and the host state of participation, organization, standby, etc.

On the other hand, if there is no change in the updated host information, the HMS 100 does not transmit the host information to the host 200 each time it receives the operation information.

To simplify control, etc., if there is no change in the host information, the host information may be transmitted to the host 200 each time the operation information is transmitted. Alternatively, the host information may be transmitted to the host 200 in response to a request from the host 200 regardless of whether or not there is change in the host information.

The host information update operation is then completed. The electronic conference system application 34 at the host 200 enables the updated host information recorded in the storage section 32 to be referenced for directly accessing the IP address of the target host to take part in a conference or summon a conference.

By the way, the host having the fixed IP address always uses the same IP address in any conference connection. Therefore, if the control section 31 at the host 200 retains a list of the hosts each having the fixed IP address in the acquired host information in the storage section 32, even if the HMS stops, etc., and it becomes impossible to access the HMS, the list retained in the storage section 32 can be referenced for directly establishing conference connection.

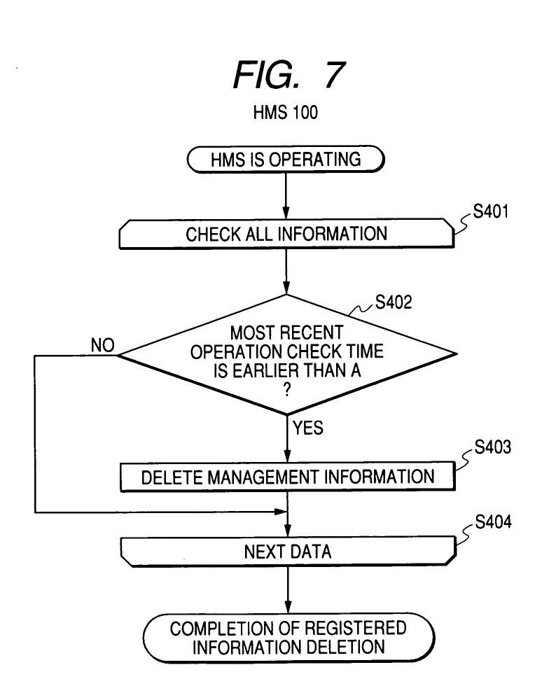

Next, the host information deletion operation of the host management apparatus will be explained with reference to FIG. 7. FIG. 7 is a flowchart to show detailed steps of the host information deletion processing of the host management apparatus.

As previously described in the host information update operation, the operation information is transmitted in a predetermined cycle from each of the hosts registered in the HMS, and the host information is updated to the most recent host information. Therefore, the host information with the registration time (update time) preceding the last host operation check time cannot usually exist.

That is, the host to which the operation information is not transmitted after the expiration of the predetermined time since the previous update is not connected to the network 300 because the conference already ends, etc. Then, the HMS deletes the host information in a predetermined cycle (for example, at the same timing as the host information update operation).

To begin with, the host information management section 15 of the HMS 100 reads all host information stored in the storage section 12 (step S401) and determines whether or not the registered host information is information registered preceding the last host operation check time (step S402).

If the registered host information is the host information registered preceding the last host operation check time, the information is deleted (step S403). Steps S402 and S403 are repeated for all host information (step S404).

The host information deletion operation of the HMS is then completed. Since unnecessary host information is deleted in the predetermined cycle, the storage capacity can be saved. If the information with the same user key or the same address exists, only the most recent information is left and the old information is deleted.

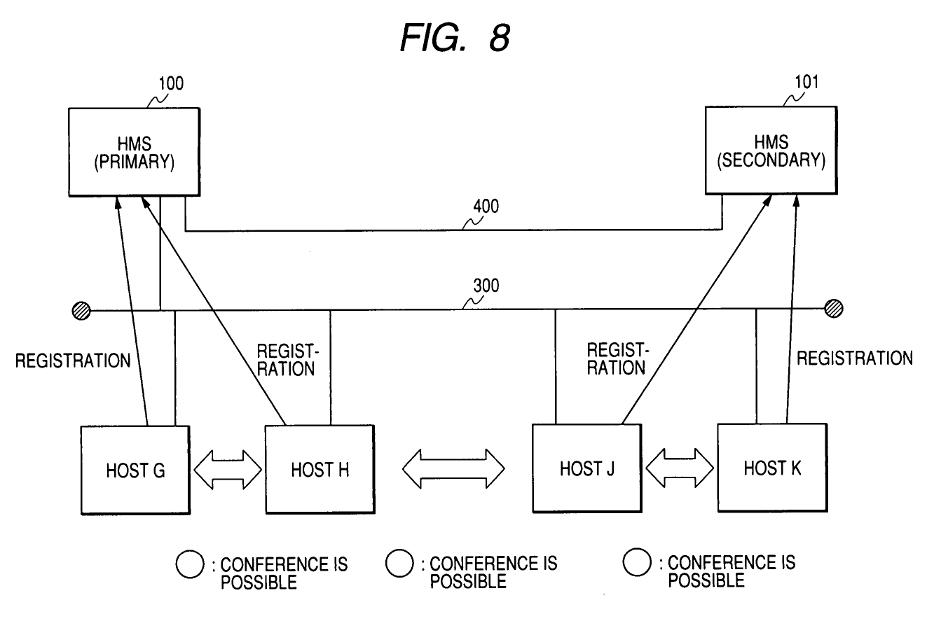

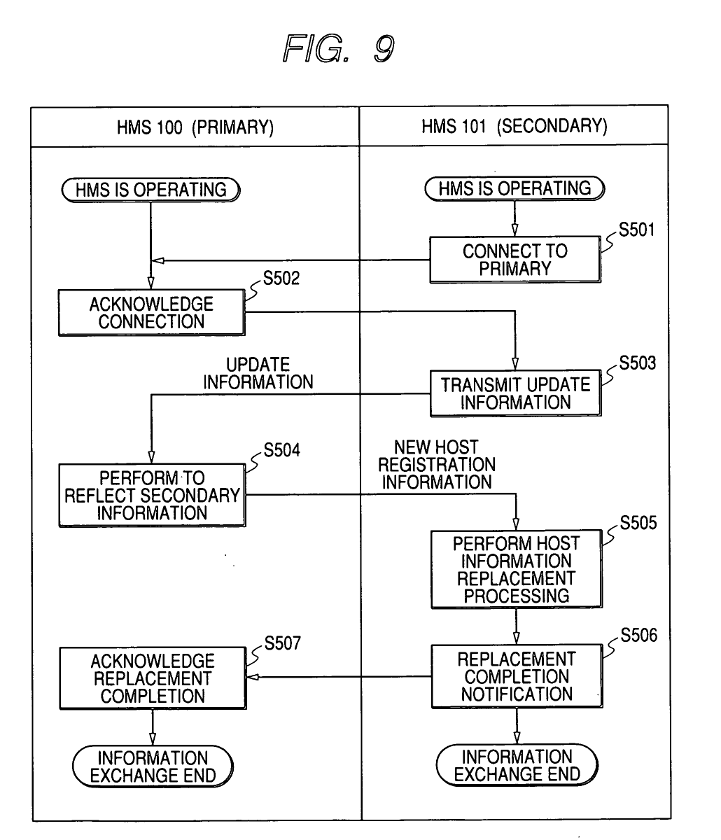

Next, the information exchange operation between the host management apparatuses will be explained with reference to FIGS. 8 and 9. FIG. 8 is a schematic diagram to show the relationship between the two host management apparatuses placed in remote locations and hosts. FIG. 9 is a flowchart to show detailed steps of HMS-to-HMS information exchange processing.

When two host management apparatuses are operated, the mutually retained information needs to be updated in a predetermined cycle so that the function of the host management apparatus can be maintained if either of the host management apparatuses stops.

For example, to place the two host management apparatuses in remote locations, different host information may be registered in each host management apparatus and thus the information also needs to be updated in a predetermined cycle to match the information.

For example, as shown in FIG. 8, each host registers information in the near HMS of the two host management apparatuses HMS 100 and HMS 101. Therefore, the host information of the hosts J and K is not registered in the HMS 100 and a situation in which the hosts H and J in the same company cannot be connected to each other for conference occurs. Thus, the host information is exchanged between the HMS 100 and the HMS 101.

Next, the HMS-to-HMS information exchange processing will be explained specifically with reference to FIG. 9.

As shown in FIG. 9, when a predetermined time (HMS-to-HMS information exchange time) has elapsed, the control section 21 of the secondary HMS 101 connects to the primary HMS 100 through the communication control section 23 (step S501). When the HMS 100 acknowledges the connection (step S502), the control section 21 transmits the host information stored in the storage section (step S503).

The host information management section 15 of the HMS 100 reflects the received host information in the host information in the HMS 100 (step S504) to update the host information. If a plurality of pieces of information containing the same user name, host name, IP address exist, the old information is replaced with the new information according a similar procedure to the update procedure in the host operation check operation described above.

The updated host information is also transmitted to the host information management section 25 of the HMS 101 and host information replacement processing is performed (step S505). After the processing is performed, the information is stored in the storage section 22. Upon completion of the processing, the control section 21 transmits a notification to the HMS 100 (step S506) and the control section 11 of the HMS 100 receives the notification (step S507).

The HMS-to-HMS information exchange processing is then completed. Since the host information stored in the HMS is thus updated in the predetermined cycle, the information in one HMS is matched with the information in the other.

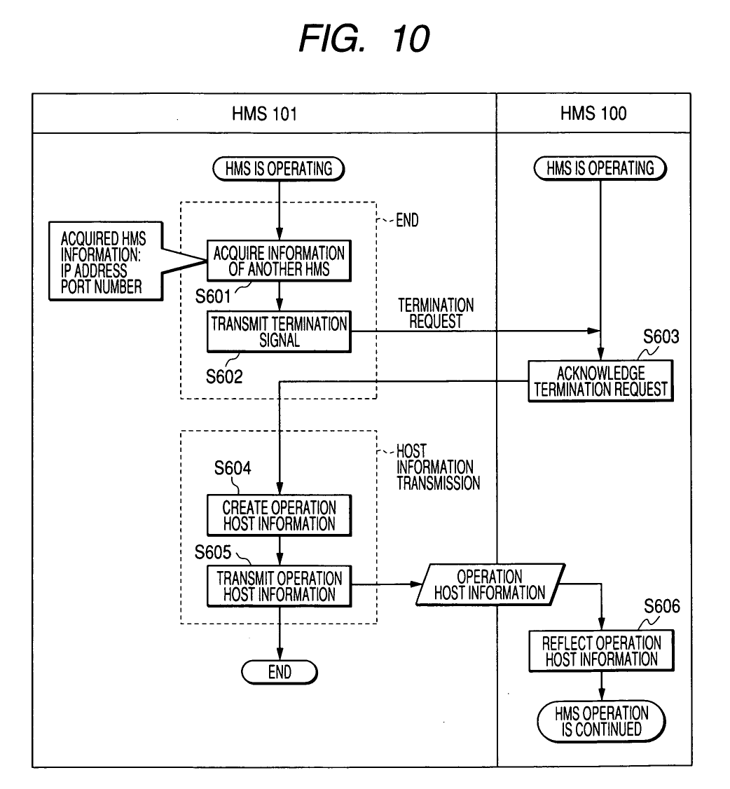

Next, the termination operation of the host management apparatuses will be explained with reference to FIG. 10. FIG. 10 is a flowchart to show detailed steps of the termination processing of the host management apparatuses. It shows processing steps applied when the secondary HMS 101 stops.

When stop operation is performed for the HMS 101, the control section 21 reads the IP address and the port number of the HMS 100 from the storage section 22 (step S601) and transmits a termination signal to the HMS 100 through the communication control section 23 (step S602).

When the control section 11 of the HMS 100 receives the termination notification and transmits an acknowledgement signal to the HMS 101 (step S603), the control section 21 of the HMS 101 reads the host information, etc., from the storage section 22 and creates operating host information (step S604).

The created operating host information is transmitted from the communication control section 23 to the HMS 100 (step S605) and the host information management section 15 of the HMS 100 reflects the received operating host information in the information in the HMS 100 (step S606) The HMS termination operation is then completed.

In the embodiment, if a plurality of HMSs are connected by a leased line, higher-security operation can be performed.

If the host keeps track of the IP addresses of a plurality of HMSs, even if the primary HMS stops, the host can register the host information by connecting to any other HMS.

If HMS is installed in a remote location as described above, the need for accessing the HMS in the headquarter from the host in a remote branch is eliminated and the communication cost involved in accessing the HMS can be decreased.

If the IP address of the HMS is previously grasped, even the host for connecting to the Internet with dialup (PC terminal, etc.,) can register the host information in HMS. Although the registered IP address is an unfixed IP address assigned by the DHCP server, it is effective as the current IP address of the host. Thus, to select the host, if the IP address is accessed, conference connection can be made. That is, the host even with an unfixed IP address can be made a host.

As described above in detail, the host management apparatus according to the embodiment is the HMS 100 placed on the network to which the hosts of the electronic conference system 1 are connected and includes the host authentication section 14 for authenticating the selected host and the host information management section 15 for registering the host information containing the IP address information of the host authenticated by the host authentication section 14. The host management method includes step S202 of authenticating the selected host and step S203 of registering the host information containing the IP address information of the authenticated host. The host management program causes a computer to provide a host authentication function of authenticating the selected host and a host information registration function of registering the host information containing the IP address information of the host authenticated by the host authentication function.

According to the embodiment, the complicated procedure in the related art of previously registering host information in all hosts to be connected for conference is not required and the number of hosts can be increased or decreased flexibly.

Registration as a host in the electronic conference system and acquisition of host information can be accomplished even in the environment in which the IP addresses are not fixed with security ensured.

What is claimed is:

1. A host management apparatus being placed on a network to which hosts of an electronic conference system are connected, comprising:
a host authentication section for authenticating a selected host; and
a host information registration section for registering host information including IP address information of a host authenticated by said host authentication section.

2. The host management apparatus according to claim 1, further comprising: a host information storage section for storing the host information of the host authenticated by said host authentication section.

3. The host management apparatus according to claim 2, further comprising: a host information update section for updating the host information stored in the host information storage section.

4. The host management apparatus according to claim 3, wherein the host information update section updates the host information in a predetermined cycle.

5. The host management apparatus according to claim 1, further comprising:
a host information exchange section for mutually exchanging the host information between said host management apparatus and another host management apparatus.

6. The host management apparatus according to claim 2, further comprising:
a host information exchange section for mutually exchanging the host information between said host management apparatus and another host management apparatus.

7. The host management apparatus according to claim 3, further comprising:
a host information exchange section for mutually exchanging the host information between said host management apparatus and another host management apparatus.

8. The host management apparatus according to claim 4, further comprising:
a host information exchange section for mutually exchanging the host information between said host management apparatus and another host management apparatus.

9. The host management apparatus according to claim 5, wherein the host information exchange section exchanges the host information in a predetermined cycle.

10. The host management apparatus according to claim 6, wherein the host information exchange section exchanges the host information in a predetermined cycle.

11. The host management apparatus according to claim 7, wherein the host information exchange section exchanges the host information in a predetermined cycle.

12. The host management apparatus according to claim 8, wherein the host information exchange section exchanges the host information in a predetermined cycle.

13. A host management method of managing hosts of an electronic conference system on a network, comprising the steps of:
authenticating a selected host; and
registering host information including IP address information of a host authenticated in said step of authenticating the selected host.

14. The host management method according to claim 13, further comprising the steps of:
storing the host information of the host authenticated in said step of authenticating the selected host;
updating the stored host information; and
acquiring host information of a host that enables to be connected for taking part in a conference.

15. A host management program of a host management apparatus being placed on a network to which hosts of an electronic conference system are connected, causing a computer to perform:
a host authentication function of authenticating a selected host; and
a host information registration function of registering host information including IP address information of a host authenticated by the host authentication function.
